(19) United States
(12) Patent Application Publication
(10) Pub. No.: US 2026/0091248 A1
(43) Pub. Date: Apr. 2, 2026

(54) ROPE CLAMPING DEVICE AND METHOD FOR CLAMPING A ROPE

(71) Applicant: ZEDEL, Crolles (FR)

(72) Inventors: Marc Jourdan, St Martin d'Hères (FR); Benoît Vuillermoz, Saint-Martin-d'Hères (FR); Alain Maurice, Le Plateau des Petites Roches (FR); Sébastien Petzl, Sassenage (FR)

(73) Assignee: ZEDEL, Crolles (FR)

(21) Appl. No.: 19/339,572

(22) Filed: Sep. 25, 2025

(30) Foreign Application Priority Data
Sep. 27, 2024 (FR) 2410413

(51) Int. Cl. A62B 1/14

(52) U.S. Cl. CPC A62B 1/14

(57) ABSTRACT

A rope clamping device comprises a body with an attachment device to a user and a first through hole receiving a rope strand. A deformable channel is formed by a plurality of links mounted consecutively behind one another between a first link and a last link. The links are attached consecutively two by two by swivel shafts and mounted swivelling around swivel axis to modify the cross-section of the channel. Each link comprises two primary contact surfaces designed to be in contact with the rope strand, the two primary contact surfaces facing one another in a direction perpendicular to the swivel axis. The two primary contact surfaces of each link are pivotally movable with respect to one another.

### BACKGROUND OF THE INVENTION

The invention relates to a rope clamping device and to a method for clamping a rope.

### PRIOR ART

When performing rope access work, a rope is installed along a substantially vertical wall and the rope access technician moves along the rope to perform different jobs. Work can be performed on trees, building walls or industrial work sites.

To be able to move easily and efficiently, it is sought to use equipment that is simple and practical. Blocking his/her position on the rope, ascending on the rope and rappelling are operations the rope access technician performs dozens of times a day. It is therefore important to have equipment that is the best suited for each of his operations while being simple to use, reliable and compact. It is also necessary to have a rope clamping device that is efficient without being too dependent on the state of wear of the rope or on its surface condition. Clamping devices are known that behave very differently depending on whether the rope is brand new or is already very worn. Devices also exist that present a mechanical behaviour that is not the same depending on whether the rope is dry, damp or dirty, for example covered with resin.

Document EP 2399651 discloses a rope clamping device marketed under the trade name ZIGZAG having a body provided with a roller and a channel of variable cross-section. The rope strand passes round a pulley, passes through the body and enters the variable cross-section channel. The channel is formed by a chain provided with several rigid annular links that are fixed behind one another by arms and folded so that the multiple through holes are aligned to allow the rope strand to pass. Each link is in contact with the rope and rubs on the rope. When the user wants to suspend himself using the body, the links move away from one another which has the effect of reducing the available cross-section for the rope strand to pass so that the latter finds itself wedged in the chain.

To descend along the rope strand, the user presses on the last link of the chain in the direction of the body. The cross-section available for the rope strand to pass increases having the effect of enabling sliding along the rope strand to take place. To ascend along the rope strand, the reverse operation is performed moving the body towards the last link until the position of the last link is moved upwards along the rope. Placing a load on the body results in deformation of the chain and clamping of the rope strand.

This product enables efficient clamping along the rope to be achieved by means of multiple links that define multiple contact points that are as many friction areas. The multiple contact points provide a large contact surface with the rope thereby enabling a fairly homogeneous behaviour to be obtained whatever the surface state of the rope.

However, installation of the clamping device requires a large quantity of rope to be run inside the different holes to place the clamping device at the right place along the rope.

A clamping device operating substantially according to the same principle is marketed by Rock Exotica under the trade name Akimbo and discloded in document WO 2017/014977. A body defines a through hole for a rope strand to pass through and a hole for attaching the user. A movable link is attached to the body and defines another hole through which the rope strand passes. The two links are openable to facilitate installation of the clamping device in the middle of the rope. The two links define two contact areas with the rope which makes this device more sensitive to the surface state of the rope. To have a more repeatable behaviour, the two links are provided with an adjustment device of the friction between each of the links and the rope. This clamping device imposes the use of a reduced set of ropes able to operate in conjunction with the clamping device.

There also exists the product marketed by Notch Equipment under the trade name "Rope Runner Pro". The clamping device has three through rings that are passed through by the rope strand to induce friction. The rings are openable or removable by means of a removable pin to enable the clamping device to be installed in the middle of the rope strand. However, it is apparent that fitting and removal of the rings to install the clamping device is not easy to perform. The configuration of the clamping device means that the rope is in continuous contact with a large surface of the body, which has the effect of reducing the efficiency of rope ascension operations.

Document US 2005/0262669 discloses a device marketed under the trade name Unicender by Rock Exotica and is also comprises four C-shaped plates arranged opposite one another to define a through channel. The four plates are installed movable with respect to one another around four rotation shafts that are connected behind one another as rotation shafts of a chain. This clamping device is not suitable for ropes that are too rigid or too flexible. It is apparent that, during ascension operations on the rope, the friction forces remain high so that the efficiency is low.

### OBJECT OF THE INVENTION

One object of the invention consists in providing a rope clamping device in which the transfer of forces between the rope strand and the channel designed to clamp the rope is better mastered.

These problems tend to be overcome by means of a rope clamping device designed to clamp a rope strand comprising: - a body provided with an attachment device designed to enable attachment to a user and a first through hole designed for a rope strand to pass through; - a channel having a first end attached to the body and designed to be passed through by the rope strand, the channel opening out facing the first through hole and being deformable between a first position and a second position, the first position having a smaller inner cross-section than an inner cross-section in the second position; wherein the channel has a plurality of links defining at least a part of the channel, the links being arranged consecutively behind one another between a first link and a last link, the links being fixed consecutively two by two by means of swivel shafts and fitted pivotally around swivel axes to modify the cross-section of the channel, each link comprising two primary contact surfaces designed to be in contact with the rope strand, the two primary contact surfaces being facing one another in a direction perpendicular to the swivel axes.

The clamping device is remarkable in that the two primary contact surfaces of each link are pivotally movable with respect to one another.

In advantageous manner, the links comprise central links located between the first link and the last link, the central links being identical, L-shaped and fixed head to tail to form the turns.

In an advantageous development, the primary contact surfaces present a non-circular cross-section around the swivel axis, the primary contact surface having a first area with a first thickness and a second area with a second thickness, the first thickness being thicker than the second thickness, the first area bounding the channel in the first position, the second area bounding the channel in the second position.

Preferentially, the first link is attached to the body, the first link being arranged pivotally with respect to the body around a rotation shaft fixed to the body.

According to one embodiment, the rotation shaft defines a rotation axis that is parallel to the swivel axes between the pairs of successive links.

In an advantageous development, a movable plate is fixed to the last link to form an openable ring defining a through passage designed to receive the rope strand, the movable plate being pivotally movable around a last rotation axis parallel to the swivel axis between the last link and the preceding link in the direction of the first link.

Preferentially, the last rotation axis is collinear with the swivel axis between the last link and the preceding link in the direction of the first link.

In advantageous manner, the last link presents a folded position and an extended position, the through passage being located in the alignment of the channel when the last link is in the folded position. A spring has a first end connected to the last link and a second end connected to a preceding link in the direction of the first link, the extended position being a position of less deformation for the spring.

It is also advantageous to provide for the links to comprise central links arranged between the first link and the last link, the central links being identical, L-shaped and fixed head to tail to form the turns.

It is a further object of the invention to provide a method for clamping a rope that is more efficient than the prior art configurations while being quite insensitive to the surface state of the rope.

This result tends to be achieved by means of a method for clamping a rope comprising the following steps: - providing a clamping device according to one of the above-mentioned configurations and a rope; - inserting a rope strand in the first through hole and in the channel; - moving the rope strand in a direction going from the first link to the last link.

### BRIEF DESCRIPTION OF THE DRAWINGS

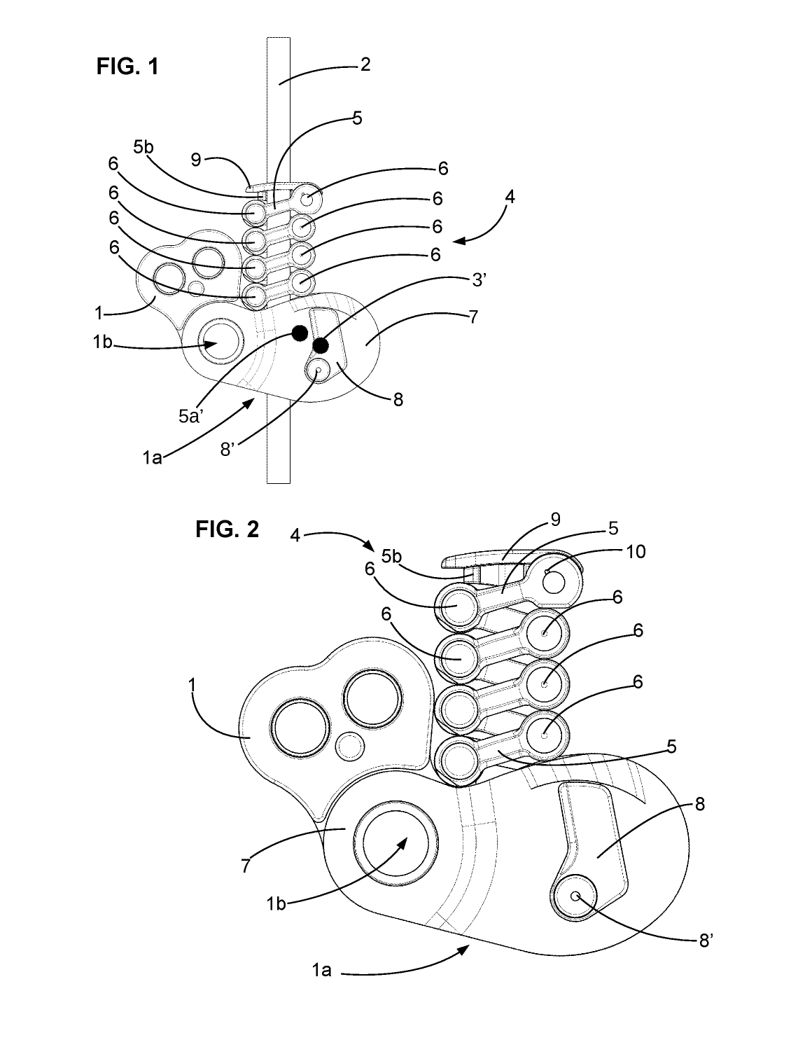

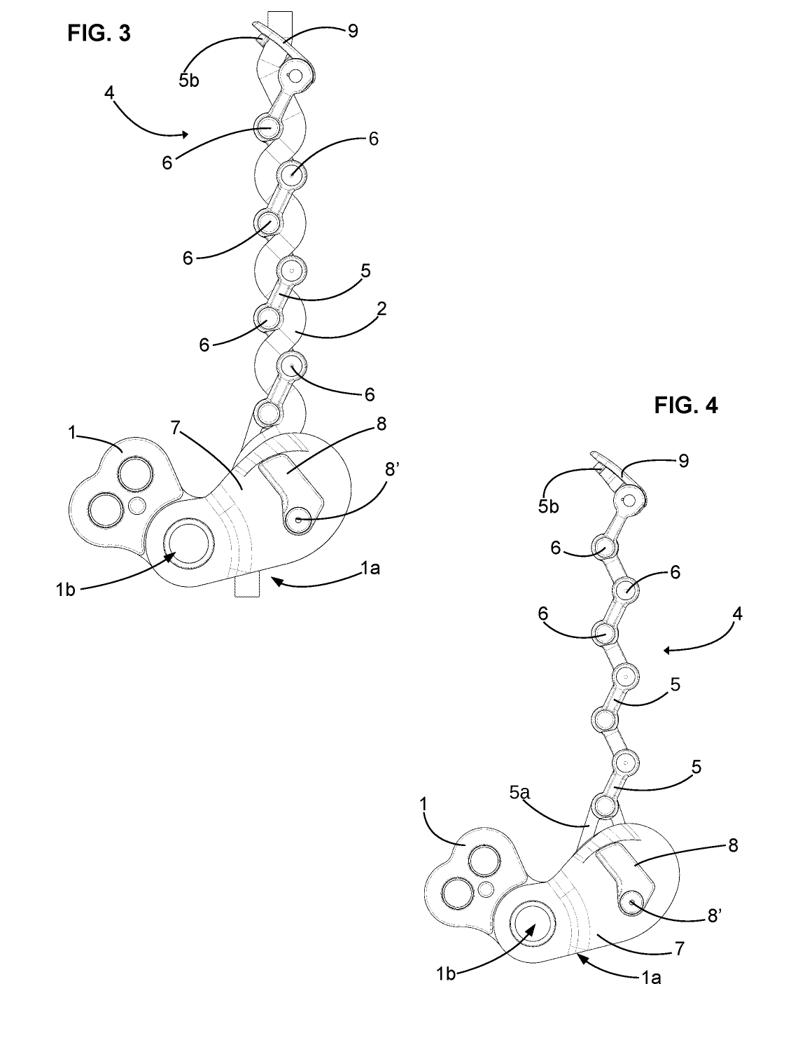

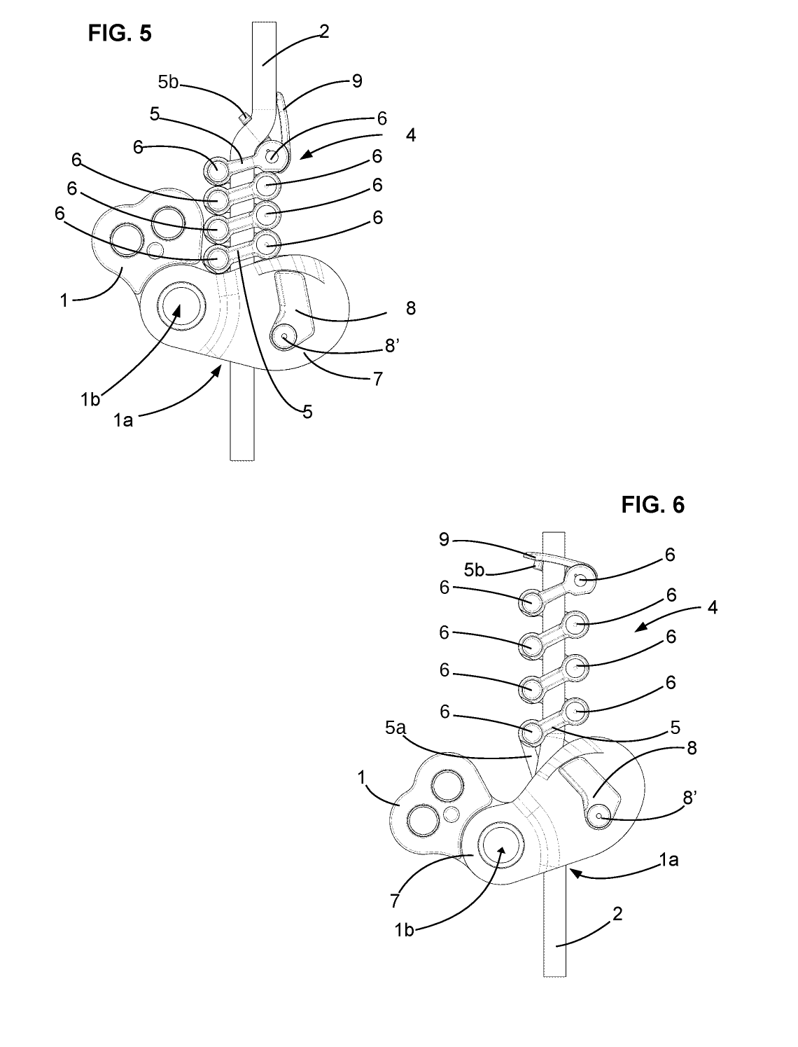

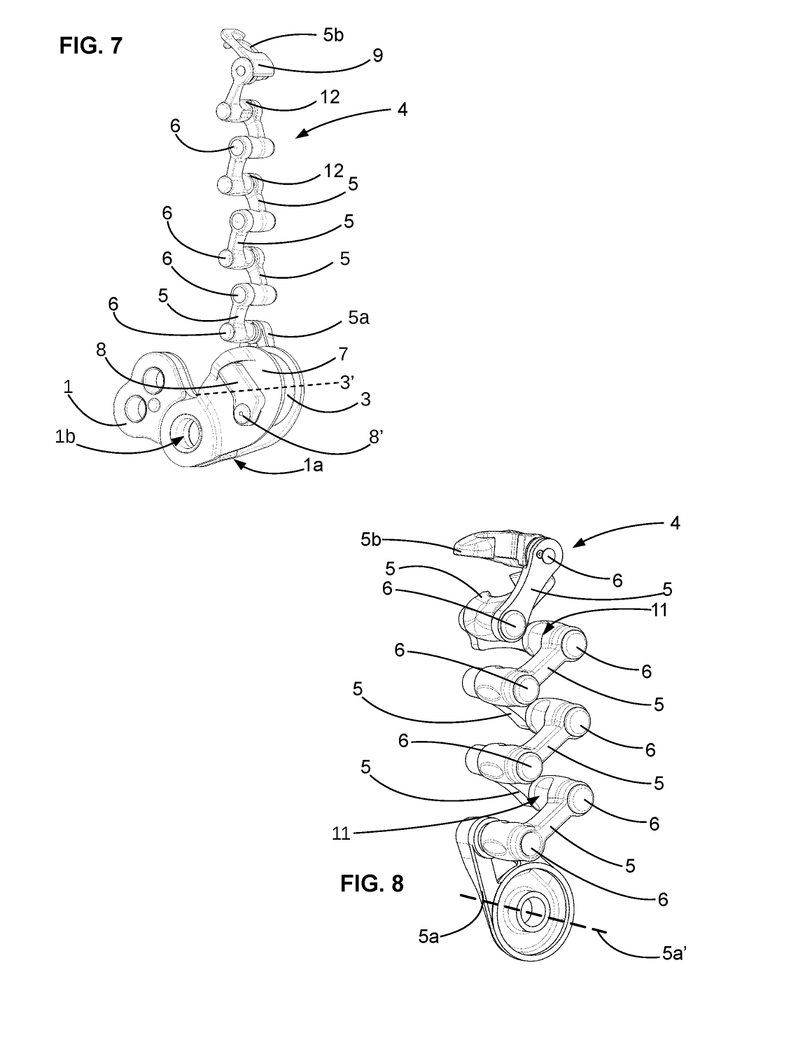

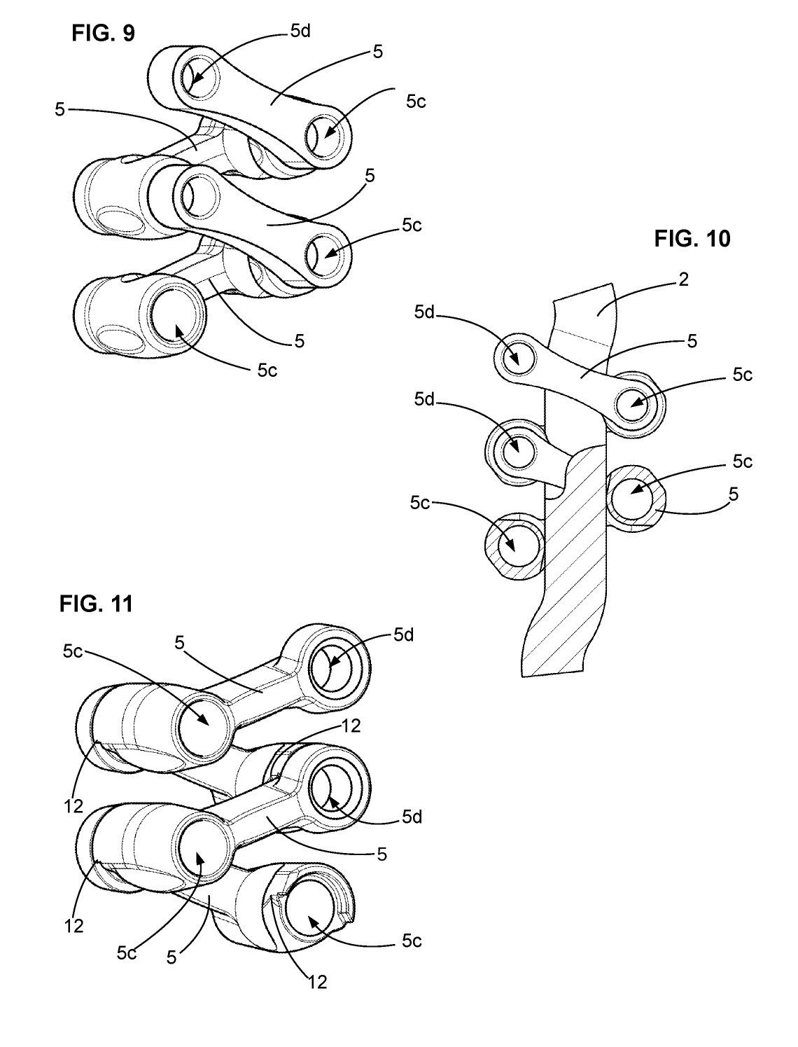

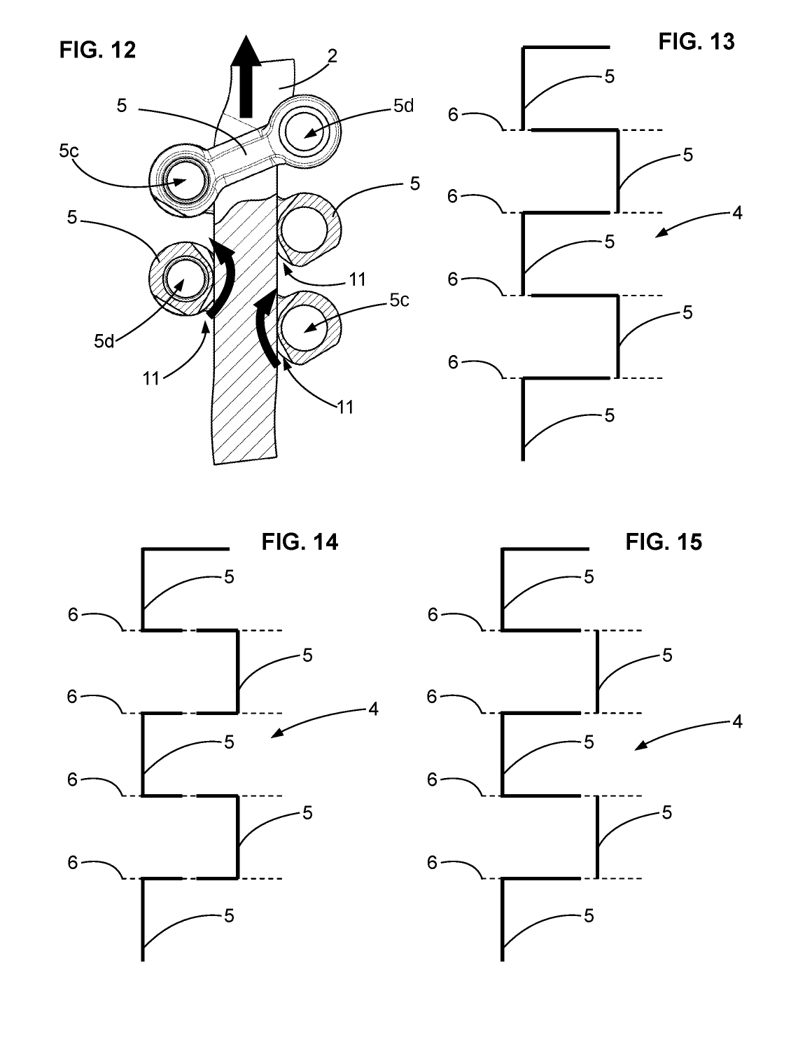

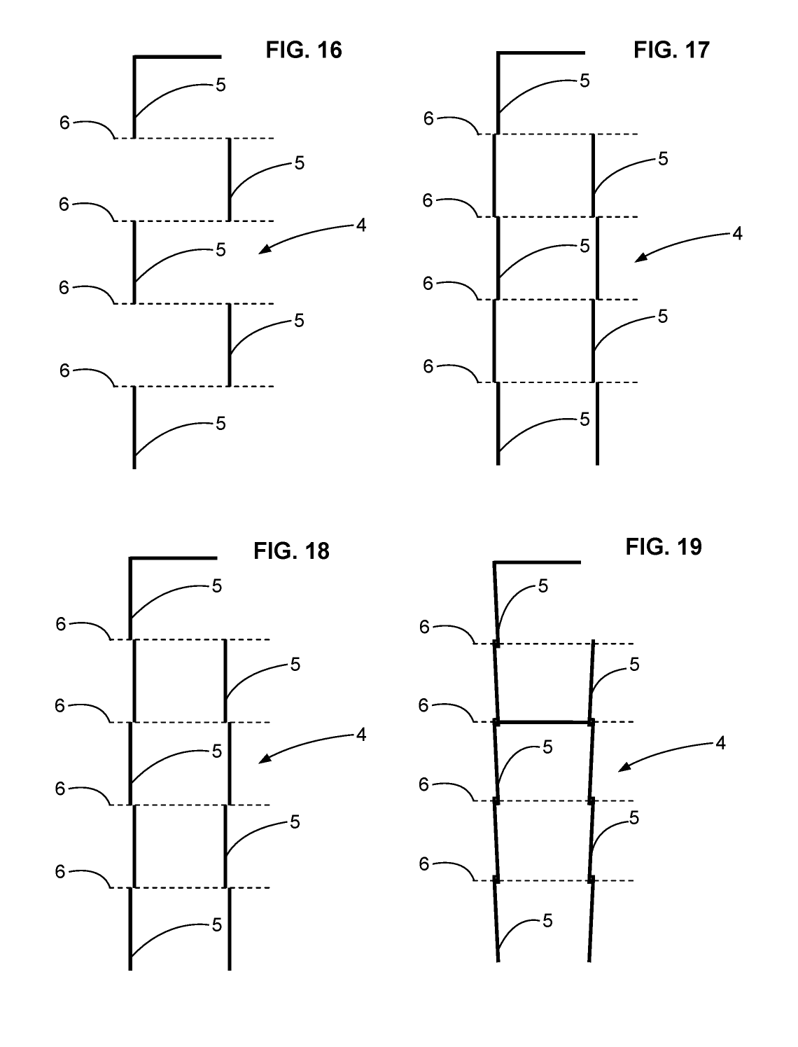

Other advantages and features will become more clearly apparent from the following description of particular embodiments and implementation modes of the invention given for non-restrictive example purposes only and represented in the appended drawings, in which:

[FIG. 1]: a schematic view of an embodiment of a rope clamping device in a sliding position with a rope installed;

[FIG. 2]: a schematic view of an embodiment of a rope clamping device in a sliding position;

[FIG. 3]: a schematic view of an embodiment of a rope clamping device in a clamping position with a rope installed;

[FIG. 4]: a schematic view of an embodiment of a rope clamping device in a clamping position;

[FIG. 5]: a schematic view of an embodiment of a rope clamping device in a sliding position with a rope installed and a last link in an extended position;

[FIG. 6]: a schematic view of an embodiment of a rope clamping device in a sliding position with a rope installed, the last link being in a folded position;

[FIG. 7]: another schematic view of an embodiment of a rope clamping device in a sliding position without a rope and with the last link in the extended position;

[FIG. 8]: a schematic view of an embodiment of a channel in a sliding position without a rope installed;

[FIG. 9]: a schematic perspective view of an embodiment of an assembly of several L-shaped links assembled in the form of a turn in the sliding position;

[FIG. 10]: a schematic cross-sectional view of an embodiment of an assembly of several L-shaped links assembled in the form of a turn in the sliding position;

[FIG. 11]: another schematic perspective view of an embodiment of an assembly of several L-shaped links assembled in the form of a turn in the sliding position;

[FIG. 12]: another schematic cross-sectional view of an embodiment of an assembly of several L-shaped links assembled in the form of a turn in the sliding position;

[FIG. 13]: a schematic view of a first embodiment of a rope clamping device in the form of a coil with L-shaped links;

[FIG. 14]: a schematic view of a second embodiment of a rope clamping device in the form of a coil with C-shaped links;

[FIG. 15]: a schematic view of a third embodiment of a rope clamping device in the form of a coil with an alternation of C-shaped links and I-shaped links;

[FIG. 16]: a schematic view of a fourth embodiment of a rope clamping device in the form of coil with I-shaped links connecting the swivel axis;

[FIG. 17]: a schematic view of a fifth embodiment of a rope clamping device with annular links in a sliding position with a rope installed;

[FIG. 18]: a schematic view of a sixth embodiment of a rope clamping device with annular links in a sliding position with a rope installed;

[FIG. 19]: a schematic view of a seventh embodiment of a rope clamping device with annular links in a sliding position with a rope installed.

### DESCRIPTION OF THE EMBODIMENTS

The rope clamping device has a body 1 provided with a first through hole 1a designed to be passed through by a rope strand 2. It is advantageous for the body 1 to be provided with a roller 3 for the rope to be able to slide easily inside the body 1. The roller 3 reduces frictions when performing rope ascension operations which is preferable to prevent the user from tiring himself out too quickly. The first through hole 1a is bounded partly by the roller 3, where appropriate. The roller 3 is installed rotating with respect to the body 1 around a roller rotation shaft 3’. The roller rotation shaft 3’ is advantageously fixed to the body 1. The position of the roller rotation shaft 3’ is represented schematically in FIG. 1.

The body 1 also defines an attachment device 1b for attaching the body 1 to the user. In the embodiments illustrated in FIGS. 1 to 7, the body 1 defines an attachment device 1b in the form of an attachment hole that is a through aperture enabling a carabiner, quick link, shackle, strap or any other piece of equipment enabling the body 1 to be connected fixedly with the user to be installed. When the user suspends himself/herself by means of the clamping device, he/she applies his weight on the body 1 resulting in application of a downward force.

The rope clamping device also comprises a clamping element 4 in the form of a channel designed to be passed through by the rope strand 2 in the extension of the first through hole 1a defined by the body 1. The channel is of variable cross-section in order to generate different friction values between the channel and the rope. The channel defines a clamping position that corresponds to a first position where the effective cross-section of the channel is small preventing the rope from sliding in the channel. The channel defines a second position where the cross-section of the channel is maximum so as to generate a minimum friction. The first position is illustrated in FIGS. 3, 4 and 7. The second position is illustrated in FIGS. 1, 2 and 5.

Between the first position and the second position, the channel defines one or more sliding positions that represent configurations where the rope is able to slide in one direction or in both directions inside the channel. FIG. 6 illustrates a sliding position where the friction force is higher than the friction force representative of FIGS. 1, 2 and 5 and lower than the friction force representative of FIGS. 3, 4 and 7.

The channel can be movable and deformable and presents at least one position where the first through hole 1a is facing the channel to define a rectilinear direction that passes through the channel and the first through hole 1a. This configuration is particularly advantageous when performing an ascension operation on the rope as it limits friction on the rope. It is particularly advantageous for the channel to be in the extension of the first through hole 1a in the second position. FIGS. 1 to 7 illustrate a configuration where the first through hole 1a is aligned with the longitudinal axis of the channel.

The channel is formed by a plurality of links 5 that are assembled to one another so as to be movable with respect to one another. The links have one or more contact surfaces with the rope that passes through the links 5 so as to generate friction forces that are able to clamp the rope strand 2 in the rope clamping device.

The channel is formed by a plurality of links 5 that define a channel in the form of a coil provided with a plurality of turns, preferably at least three turns. The turns are mounted movable with respect to one another by means of the swivel shafts 6. The turns move with respect to one another to increase or reduce the cross-section of the channel receiving the rope strand 2. The turns move with respect to one another to increase or reduce the length of the channel. The length is measured in the longitudinal direction of the rope that passes through the channel. When the length of the channel increases, the cross-section of the channel decreases. When the length of the channel decreases, the cross-section of the channel increases until it reaches a maximum value that is preferentially representative of the links 5 pressing on one another. What is meant by pressing on one another is that the swivel shafts 6 of the turns are pressing on one another on both sides of the space receiving the rope strand 2. The channel is in its position of smallest length. Advantageously, each turn is mounted movable with respect to the immediately adjacent turn by means of a swivel shaft 6. In even more advantageous manner, the multiple swivel shafts 6 define swivel axis that are parallel to one another.

The plurality of turns of the channel can have one or more central turns that are immediately adjacent to two other turns, one and/or both of which can also be central turns. A central turn is connected to each of the immediately adjacent turns by a swivel shaft 6. It is advantageous for the swivel shafts 6 to define swivel axes that are parallel to one another. It is even more preferable for the swivel shafts 6 to be arranged alternately on one side and then the other of the space of the channel designed to receive the rope strand 2.

For ease of installation of the rope strand 2 in the clamping device, the links 5 are not closed links, i.e. annular links as in the product marketed under the trade name ZIGZAG. The links 5 are assembled to one another to form the coil and can be in a single piece and identical. They are advantageously L-shaped as illustrated in the different embodiments of FIGS. 1 to 12. It is further possible to provide the links 5 having different shapes, for example with C-shaped parts and I-shaped parts. It is further possible to provide the links 5of any shape that is compatible with formation of a plurality of turns. The links are arranged one behind the other and are attached to one another. Two consecutive links 5 are mounted swivelling with respect to one another by means of a swivel shaft 6. It is advantageous to provide for the end links not to be identical to the other links in order to enhance movement of the channel with respect to the body 1 and to have a better following of the movements of the rope in the channel.

The coil is a coil with deformable turns. The turns deform by swivelling around the swivel shafts 6. Except for the end links, each link 5 is fixed to its two closest neighbouring links 5 by swivel shafts 6. In the different illustrated embodiments, the links 5 are L-shaped and are mounted head to tail so as to form a channel in the form of a coil.

It is particularly advantageous for each link 5 to have at least two contact surfaces with the rope. The two contact surfaces belong to two different walls, for example a wall that forms an arm between two swivel shafts and the other wall that is a covering wall of a swivel shaft 6. It is even more advantageous for the two walls to be rigidly secured to one another. The use of two walls rigidly secured to one another makes it possible to have a good transfer of forces from one end of the link to the other, and therefore to have an efficient transfer of forces between the rope strand 2 and the whole of the link 5.

The plurality of links 5 comprise a first link 5a that is a link 5 attached to the body 1. The first link 5a performs the attachment between the channel and the body 1. It is advantageous for the first link 5a to be attached to a rotation shaft 5a’ fixed to the body 1. This enables the channel to be made to swivel with respect to the body 1 in order to better adjust to a displacement of the centre of gravity of the user suspended by means of the clamping device.

In a particular embodiment where the clamping device has a roller 3, the rotation axis of the first link 5a with respect to the body 1 passes through the roller 3. In the different illustrated embodiments, the rotation axis of the first link 5a is offset from the rotation axis of the roller 3. The offset of the two axes of rotation makes it possible to have the first link 5a that is pressing against the body 1 when the first link 5a swivels beyond a threshold position. Once the threshold position has been reached or slightly before, the rope strand 2 can be wedged between the roller 3 and the first link 5a, or even between the body 1 and the first link 5a depending on the configuration of the body 1.

It is advantageous for the swivel axis of the first link 5a to be parallel to the rotation axis of the roller 3. It is advantageous for the swivel axis of the other links to be parallel to the rotation axis of the roller 3. The rotation axis of the roller 3 is illustrated schematically in FIG. 7 by a dashed line.

To be able to install a middle of the rope in the clamping device without having to run the rope from one end, it is advantageous for the body 1 to define a groove that opens into the first through hole 1a or for the body 1 to be provided with a movable flange 7.

The movable flange 7 is fitted movable between an open position allowing lateral insertion of the rope strand 2 in the first through hole 1a and a closed position preventing said lateral insertion of the rope strand 2. In the different illustrated embodiments, the configuration with the movable flange 7 is advantageous as it enables a body 1 to be provided that is more resistant to the forces applied while remaining compact. The configuration with a movable flange also enables a better trade-off to be provided between safety and ease of installation of the rope strand 2. FIGS. 1 to 7 only illustrate the movable flange 7 in the closed position.

In an advantageous embodiment, the body 1 is provided with a roller 3 and a movable flange 7, the movable flange 7 being mounted swivelling between an open position and a closed position, the open position allowing lateral insertion of the rope strand 2 in the first through hole 1a. The closed position prevents lateral insertion of the rope strand 2 in the first through hole 1a. The roller 3 and the movable flange 7 partially bound the first through hole 1a. The roller 3 is mounted rotatable around a rotation axis of the roller 3 and the first through hole 1a is located between the rotation axis of the roller 3 and the attachment device 1b. The movable flange 7 is mounted movable with respect to the roller 3 around a rotation shaft of the movable flange formed by the attachment device 1b. When the user is suspended by means of the clamping device, a tensile force is applied between the attachment device 1b and the roller 3 having the effect of slightly deforming the body 1 thereby preventing the movable flange 7 from leaving the closed position.

In a particular embodiment illustrated in FIGS. 1 to 7, the movable flange 7 is associated with a latch 8. The latch 8 presents a latched position and an unlatched position. The latched position prevents movement of the movable flange 7 away from the closed position. The unlatched position enables movement of the movable flange 7 away from the closed position.

In advantageous manner, the movable flange 7 is fixed to the roller rotation shaft 3’ when the movable flange 7 is in the closed position. To ensure maximum safety preventing accidental opening of the movable flange 7, the latch 8 has two distinct triggers which have to be shifted consecutively to enable the movable flange 7 to move away from the closed position.

In a particular embodiment, actuation of the latch 8 is independent from the position of the channel and the extension of the channel. Preferentially, the latch 8 is mounted swivelling around a locking shaft 8’ that is fixed to the body 1 or to the movable flange 7.

In a preferential embodiment, the channel is terminated by a last link 5b associated with a movable plate 9. The movable plate 9 is fixed to the last link 5a or is fixed to the swivel shaft 6 of the last link 5a. The movable plate 9 transforms the last link 5a into an openable ring. The movable plate 9 can be L-shaped, C-shaped, I-shaped or of another shape to form an openable ring. In the absence of an openable ring, the rope strand 2 can escape from the last link 5a more easily, thereby requiring a more rigid rope. It is also possible to provide for the last link 5a to have a slightly different shape from that of the other links 5 in order to make undesired escape of the rope strand 2 more complicated. It is advantageous for the links 5 to be in contact with one another so as to cover the whole length of the swivel shafts, thereby preventing any contact between an outside element and the swivel shaft 6.

The movable plate 9 is mounted movable with respect to the last link 5a between an open position and a closed position. In the open position, the movable plate 9 is offset from the last link 5a to allow insertion of the rope strand 2 in the ring. In the closed position, the movable plate 9 is in contact with the last link 5a or close to the latter to prevent extraction of the rope strand 2 from the ring. The last link 5a is the link the farthest from the body 1 in the direction of the rope strand 2 that passes through the channel.

In the illustrated embodiments, the movable plate 9 is mounted swivelling with respect to the last link 5a around a last rotation axis. More preferentially, the movable plate 9 is mounted swivelling around a swivel axis that is parallel to the swivel axis of the last link 5a with the preceding link 5. Even more preferentially, the last link 5a and the movable plate 9 swivel around a rotation axis that is collinear with the swivel axis of the last link 5a and, even more preferentially the swivel axis is the same. Such an embodiment is illustrated in FIGS. 1 to 8. It is also possible to have a translational movement, swivelling around another swivel axis or a more complex movement. It is further possible to have a movable plate 9 that is removable with respect to the last link 5a to define the open position and the closed position.

In order to have a channel that follows the movements of the rope strand 2 in the longitudinal direction of the rope as faithfully as possible, it is advantageous for the last link 5a to be biased by a spring 10 to a position that represents a reduced cross-section with respect to the rest of the channel in the position representative of a maximum cross-section. Reducing the efficient cross-section with respect to the rest of the channel makes it possible to form a last link 5b that is always in contact with the rope strand 2. FIGS. 1 to 7 illustrate an embodiment where the last link 5a is associated with a movable plate 9, whereas the embodiment of FIG. 8 illustrates a clamping element 4 devoid of the movable plate 9.

When the rope strand 2 moves in a direction that extends from the body 1 to the last link 5a, i.e. in a direction representative of downward sliding of the clamping device with respect to the rope strand 2, the last link 5a drags the channel upwards. As the channel lengthens, the cross-section decreases progressively thereby increasing the number of contact points with the rope and therefore the intensity of the friction until the friction force is sufficient to obtain clamping of the rope strand 2. The frame being fixed, movement of the clamping device in a direction that extends from the last link 5a to the first link 5a is designed to result in systematic clamping of the rope strand 2. To prevent this clamping, the user has to press on the last link 5a to move the latter towards the first link 5a and adjust the value of the friction force to adjust the speed of sliding along the rope.

On the contrary, when the rope strand 2 moves in a direction that extends from the last link 5a to the body 1, i.e. in a direction representative of upward sliding of the clamping device with respect to the rope strand 2, the last link 5a drags the channel downwards. As the channel shortens, the cross-section increases progressively thereby reducing the number of contact points with the rope and therefore the intensity of the friction until the friction force is equal to the force applied by the spring 10 where appropriate.

To obtain a good sensitivity between the rope and the last link 5a, it is not necessary to have a very stiff spring 10 as this introduces a strong friction when ascending on the rope. It is preferable to have a last link 5b that is mounted swivelling over at least 45°, preferably at least 75° or even at least 90°. The deformation introduced by the last link 5a enables a good sensitivity to be had for both rigid ropes and flexible ropes.

To move the last link 5a, with respect to the rest of the channel, to a position of small cross-section, it is advantageous for one end of the spring 10 to be attached to the last link 5a and for the other end of the spring 10 to be attached to the preceding link, i.e. in the direction of the first link 5a.

The last link 5a moves between a folded position and an extended position. In the folded position, the cross-section available for passage of the rope strand 2 is larger than the available cross-section in the extended position. The folded position can be a position where one end of the last link 5a is in contact with the swivel shaft 6 between the preceding link and the link that precedes it in the direction of the first link 5a.

The extended position is a position of lesser deformation for the spring 10.

In the illustrated embodiments, the movable plate 9 is located above the last link 5a. It is possible to provide for the movable plate 9 to be located between the last link 5a and the next to last link. It is further possible to provide for the spring 10 to have one end fixed to the movable plate 9.

Between the first link 5a and the last link 5a, it is advantageous to have central links. Preferentially, the central links are all identical. The number of central links can vary so as to generate more or less friction.

In advantageous manner, the links 5 have hollow walls or holes for one or two swivel shafts to pass. As illustrated in FIG. 9, an L-shaped link has a first wall defining a bottom through hole 5c designed to receive a first of the swivel shafts 6 and a top through hole 5d designed to receive a second of the swivel shafts 6. Bottom through hole 5c of a reference link is located facing top through hole 5d of a preceding link and top through hole 5d of the reference link is located facing bottom through hole 5c of a following link. A preceding link is a link situated closer to the first link 5a and a following link is a link situated closer to the last link 5a when running along the coil.

It is also possible to have the links 5 where the swivel shafts or a part of the swivel shafts is designed to come into direct contact with the rope strand 2.

FIGS. 13, 14, 15 and 16 illustrate different possible embodiments to form a channel that presents the form of a coil. The links 5 are present in a fully stretched configuration with a spacing between the parts used to form the links 5so as to better illustrate the interactions between the links 5.

FIG. 13 illustrates L-shaped links 5 illustrated in FIGS. 1 to 12. FIG. 14 illustrates C-shaped links arranged head to tail. FIG. 15 illustrates an alternation of C-shaped links and I-shaped links. FIG. 16 illustrates I-shaped links the ends of which are passed through by the swivel shafts 6. The embodiment illustrated in FIG. 13 seems to be the most advantageous as it uses a large number of identical parts and procures a good ratio between mechanical stress resistance, efficiency and compactness.

In a particular embodiment, the channel is formed by a plurality of links 5 that define a coil equipped with deformable turns to better adjust the cross-section of the channel to requirements, in particular as regards friction. It is particularly advantageous to have the links 5 that are L-shaped where each link 5 is connected to the adjacent link 5 by a pivot link defined by a swivel shaft 6 and where the main contact points operate independently from the following and/or preceding contact point in the longitudinal direction of the rope strand 2.

When the rope strand 2 attempts to lengthen the channel, each contact surface applies one or more forces on the links 5 that tend to deform the turns. In the embodiment illustrated in FIG. 13, the contact surfaces between the rope strand 2 and the areas passed through by the swivel shafts 6 apply opposite forces around the two swivel axes of each link. This has the effect of generating a friction force that increases rapidly. Furthermore, with L-shaped links, the wall that joins the two swivel shafts 6 can be in contact with the rope strand 2 thereby introducing an additional friction that acts to make the link 5 swivel.

Consequently, each contact surface with the rope works to the same end to increase or reduce the cross-section of the channel. The channel is able to clamp the rope after a small movement of the rope in the direction of the last link 5a. The last link 5a and in more general manner all the links located above the swivel shaft 6 of a reference link apply a force on the swivel shaft 6 that tends to move the links 5 towards one another so that they are all aligned. The force applied on the reference link seeks to perform clamping of the rope. In addition to this force, the friction introduced by the rope strand 2 that rubs against the wall of the link passed through by the swivel axis generates a torque that is also directed to perform clamping of the rope strand 2.

To adjust the cross-section of the channel efficiently and ensure efficient clamping and releasing, the channel has primary contact surfaces with the rope that are arranged alternately on one side of the rope strand 2 and the other. The primary contact surfaces are formed by the walls of the swivel shafts 6 or by the walls of the links separating the rope and the swivel shaft 6. It is possible to have secondary contact surfaces formed by the walls of the arms that connect the swivel shafts 6. It is advantageous to limit the friction generated by the secondary contact surfaces, as the deformation of the channel has little effect on the secondary contact surfaces.

To have a good transmission of forces between the rope and channel, it is advantageous for the links 5 to have a single primary contact surface. In other words, the two adjacent primary contact surfaces are pivotally movable with respect to one another.

In a coil arrangement, the turns move by swivelling around the swivel shafts. It is particularly advantageous for each link not to present a rigid assembly between two primary contact surfaces. Preferentially, each link 5 has a single primary contact area that is located between one of the two swivel shafts 6 and the rope strand 2. In addition to this, primary contact surface link 5 can have at least one secondary contact surface on the wall of the arm connecting two swivel shafts 6. It is advantageous for the at least one secondary contact surface, in a link 5, to be arranged in fixed manner with the primary contact surface. The use of an L-shaped link enables a link to be formed with a single primary contact surface and a single secondary contact surface. The primary surface and the secondary surface are mounted in fixed manner relative to each other. The L-shaped link can be a monolithic element or it can be made of several parts, for example with an arm that attaches fixedly to the primary surface so that the primary surface and the secondary surface are fixedly mounted relative to each other.

This assembly is more advantageous than that of the device illustrated in FIG. 15 or that marketed by the applicant under the ZIGZAG trade name where an alternation of annular links exists connected by plates as in a bike chain. The two walls passed through by consecutive swivel shafts 6 form a single-piece unit. The two ends of the link receive opposite torques so that one of the torques enhances clamping whereas the other torque enhances release of the rope.

The configuration according to FIG. 13 is more advantageous than that utilised in the device marketed under the UNICENDER trade name by Rock Exotica where all the swivel axis are located on the same side of the channel. Adjustment of the active cross-section of the channel is more difficult to achieve, thereby imposing the presence of a top link of small cross-section to make the rope strand 2 deform. This configuration is detrimental to efficient ascension on the rope.

Although the figures illustrate L-shaped monolithic links to facilitate insertion of a middle of a rope, other shapes are possible, for example C-shaped monolithic links. The part of the link 5 passed through by the swivel axis with respect to the preceding adjacent link is secured in fixed manner to the wing or the two wings that are designed to receive the swivel shaft 6 of the link that follows. It is then possible to form a substantially identical configuration to that of the currently marketed ZIGZAG while being more sensitive to a movement of the rope inside the channel. As pointed out in the above, the C-shaped links defining two primary contact surface per link are less favourable.

FIGS. 17, 18 and 19 illustrate configurations where the links 5 are arranged behind one another to define annular links that are passed through by the rope strand 2.

FIGS. 17, 18 and 19 illustrate configurations where the channel is formed by a series of annular links. In other words, two swivel shafts are connected by two arms. The two arms and the two swivel shafts bound the area designed to receive the rope strand 2. When the links are annular, it is advantageous for the body 1 not to have a groove for insertion of a middle of a rope and a movable flange 7.

In order to have a channel that switches more quickly from a high-friction configuration to a low-friction configuration for a predefined movement of the rope in the first through hole 1a, it is advantageous to use a contact surface of non-circular cross-section. This embodiment is illustrated in FIGS. 1 to 12. The contact surface can be the wall of the link 5 passed through by the swivel shaft 6 and substantially parallel to the swivel axis. The contact surface can be the swivel shaft 6 when the latter is designed to be in contact with the rope strand 2. The contact surface is a part of the wall that passes round the swivel axis and that is designed to be in contact with the rope.

When the contact surface is of circular cross-section in the portion passed through by the swivel shaft 6, the increase or reduction of the cross-section in the channel is defined solely by swivelling of the links with respect to one another, which results in the swivel shafts 6 being moved towards or away from one another. On the contrary, by using the links 5 where the contact surface is not circular, swivelling of the links 5 with respect to one another results in the swivel shafts 6 being moved towards or away from one another associated with thickening or thinning of the wall of the link that is closest to the rope strand 2, i.e. the wall of the link that has to make contact with the rope strand 2. In addition to deformation of the turns, the thickness of the wall of the link 5 increases or decreases, thereby making the channel more sensitive to the movements of the rope strand 2.

It is particularly advantageous for swivelling of the link 5 to lengthen the channel to simultaneously result in insertion of a wall of the link 5 bounding the thicker channel. As a corollary, swivelling of the link 5 to shorten the channel results in insertion of a wall of the link 5 bounding the channel that is less thick. This configuration is particularly advantageous in ascension on a rope where it is sought to descend as little as possible after each upward movement of the clamping device along the rope. It is particularly advantageous for the primary contact surface not to be a circular contact surface. Rotation of the primary contact surface enables the value of the cross-section of the channel to be adjusted.

Variation of the thickness of the wall forming the link 5 can be obtained by providing a flat surface or a partial groove 11 that is designed to demarcate the cross-section of the channel when the channel is in the low-friction position. It is also possible to form a link wall provided with a protuberance. The protuberance is designed to demarcate the channel when the channel is in the high-friction position.

In an advantageous embodiment, one or more central links are provided with a limiter. The limiter is arranged to prevent maximum swivelling of a central link with respect to the immediately adjacent central link beyond a threshold position around the swivel shaft 6 shared by the latter. It is advantageous for the limiter to prevent having two successive central links that are aligned, i.e. for the limiter to prevent a straight line from passing through three swivel axes located consecutively in the longitudinal direction connecting the first link 5a to the last link 5a. The three swivel axes are the swivel axis common to the two central links defining the limiter, the swivel axis between the one of the two central links and the swivel shaft 6 common with another link situated immediately after in the longitudinal direction of the channel, and the common swivel axis between the other of the two central links and yet another of the links that is situated immediately after in the longitudinal direction of the channel.

The presence of the limiter prevents the two central links from being placed in a position that defines a hole for passage of the rope that presents movement kinematics of the links 5 that are not suitable for the stresses to be withstood. For example, when the links 5 are provided with a protuberance, a flat surface or a partial groove 11, the direction of swivelling of the links 5 with respect to one another modifies the ability to make the cross-section of the channel vary in accordance with the swivelling of the links 5.

It is particularly advantageous for the couples of two consecutive central links to both be provided with a limiter that defines the angular swivelling range between two consecutive central links. The presence of a limiter that prevents alignment of the central links facilitates almost automatic placing of the links in a position of least space occupation corresponding to a channel presenting a large cross-section. In the absence of stress, the links tend to move towards one another when the channel is located above the body 1. The risks of incorrect installation of the rope are reduced.

The maximum swivelling angle can be defined to allow clamping of a rope having a smaller diameter than a recommended diameter range. The closer total alignment of the central links is approached, the smaller the diameter of the usable rope can be. By preventing the central links from all being aligned, the risk of improper use where clamping of the rope in the channel is mainly performed by the first link 5a is reduced. Making the links work in a loading mode that is less advantageous than with a rope in the recommended diameters is prevented. It is possible for all the couples of successive links to define a limiter.

The limiter can be formed by stops 12 that are present on the links 5 and that are in contact with one another to prevent swivelling of the links with respect to one another once the threshold position has been reached.

Installation of the rope in the clamping device comprises insertion of the rope strand 2 in the first through hole 1a. Installation also comprises insertion of the rope strand 2 in the coil. The rope strand 2 is wound following the orientation of the turns so as to be inserted inside the coil.

When the rope strand 2 is moved in the direction extending from the first link 5a to the last link 5a, the channel tends to be lengthened resulting in clamping of the rope strand 2. When the rope strand 2 is moved in the direction extending from the last link 5a to the first link 5b, the channel tends to be shortened resulting in releasing of the rope strand 2.

1. Device designed to clamp a rope strand comprising:
a body provided with an attachment device designed to enable attachment to a user and a first through hole designed for a rope strand to pass through;
a channel having a first end attached to the body and designed to be passed through by the rope strand, the channel opening out facing the first through hole and being deformable between a first position and a second position, the first position having a smaller inner cross-section than an inner cross-section in the second position;
wherein the channel has a plurality of links defining at least a part of the channel, the links being arranged consecutively behind one another between a first link and a last link, the links being fixed consecutively two by two by means of swivel shafts and fitted pivotally around swivel axes to modify the inner cross-section of the channel, each link comprising two primary contact surfaces designed to be in contact with the rope strand, the two primary contact surfaces being facing one another in a direction perpendicular to the swivel axis;
characterised in that the two primary contact surfaces of each link are pivotally movable with respect to one another.

2. Rope clamping device according to claim 1 wherein the links comprise central links arranged between the first link and the last link, the central links being identical, L-shaped and fixed head to tail to form the turns.

3. Rope clamping device according to claim 1 wherein the primary contact surfaces present a non-circular cross-section around the swivel axes, the primary contact surface having a first area with a first thickness and a second area with a second thickness, the first thickness being thicker than the second thickness, the first area bounding the channel in the first position, the second area bounding the channel in the second position.

4. Rope clamping device according to claim 1 wherein the first link is attached to the body, the first link being mounted pivotally with respect to the body around a rotation shaft fixed to the body.

5. Rope clamping device according to claim 4 wherein the rotation shaft defines a rotation axis that is parallel to the swivel axes between the pairs of successive links.

6. Rope clamping device according to claim 1 wherein a movable plate is fixed to the last link to form an openable ring defining a through passage designed to receive the rope strand, the movable plate being pivotally movable around a last rotation axis parallel to the swivel axis between the last link and a preceding link in a direction of the first link.

7. Rope clamping device according to claim 6 wherein the last rotation axis is collinear with the swivel axis between the last link and the preceding link in the direction of the first link.

8. Rope clamping device according to claim 6 wherein the last link presents a folded position and an extended position, the through passage being arranged in the alignment of the channel when the last link is in the folded position, wherein a spring has a first end connected to the last link and a second end connected to a preceding link in the direction of the first link, the extended position being a position of lesser deformation for the spring.

9. Rope clamping device according to claim 1 wherein the links comprise central links arranged between the first link and the last link, the central links being identical, L-shaped and fixed head to tail to form turns of a channel taking the form of a coil.

10. Method for clamping a rope comprising the following steps:
providing a clamping device according to claim 1 and a rope;
inserting a rope strand in the first through hole and in the channel;
moving the rope strand in a direction going from the first link to the last link.
